(19) United States
(12) Patent Application Publication
(10) Pub. No.: US 2017/0020156 A1
(43) Pub. Date: Jan. 26, 2017

(54) VEGETABLE-BASED CHEESE AND METHOD OF MAKING THE SAME

(71) Applicant: Aniceto González Rodríguez, San Luis Potosi (MX)

(72) Inventor: Aniceto González Rodríguez, San Luis Potosi (MX)

(21) Appl. No.: 15/166,127

(22) Filed: May 26, 2016

Related U.S. Application Data
(60) Provisional application No. 62/166,662, filed on May 26, 2015.

(51) Int. Cl. A23C 20/02

(52) U.S. Cl. CPC A23C 20/025

(57) ABSTRACT

In one or more embodiments, a vegan cheese product may be produced. The process may comprise preparing an emulsion of a vegetable protein concentrate and an emulsifier, utilizing a two-step homogenization process.

### FIELD OF THE INVENTION

The invention generally relates to the production of dairy substitutes prepared from vegetable matter.

### INFORMATION

The steady increase of the world population has motivated the search for new food alternatives in order to obtain essential nutrients for human dietary needs. In addition, technological limitations and other factors prevent optimal distribution of food around the planet. Against this background, a growing trend encourages people to consume products of vegetal origin, because they are considered healthier due to their low saturated fat and cholesterol content, as well as their high content of dietary fiber. Further, vegetable protein is more efficient to produce than animal-based protein.

Cheese analogues may be defined as products in which individual constituents, including non-dairy fats and/or proteins are formulated to produce a cheese-like product to meet specific requirements. The market demand for these products is on the rise for a range of reasons, including but not limited to easier production and lower cost as compared to dairy-based cheese, as well as the increasing consumer interest in consumers to consume foods with less total fat, saturated fat, cholesterol and calories.

In this context, there have been attempts to develop processes for producing suitable cheese substitutes from vegetable protein sources. Such is the case of cheese analogues made principally of soy protein and with similar color, texture, taste and form as cheese. Current processes often require additional production steps, requires time and energy, and may not result in a shelf-stable cheese substitute products unless additional steps are taken such as pasteurization and/or refrigeration.

Therefore, there is a need for more production and storage friendly cheese substitute products and methods for making the same.

### SUMMARY

A vegetable protein cheese substitute (“vegan cheese product” or “VCP”) may be formulated and manufactured for consumption. In an embodiment, the cheese substitute has low to virtually no cholesterol, and is low in fat.

Dairy-based cheese typically contains up to 24% fat, 20% proteins, and 46% water and a small quantity of carbohydrates. In spite of being a good source of protein, conventional cheese typically has a high level of saturated fat. Saturated fats are commonly found in food products, and especially those with an animal origin. In other products saturated fats are intentionally added to the food product to give the product the desired texture, flavor, and/or structure as their functional properties such as the high fusion temperature make them suitable in many applications.

Nevertheless, consumption of saturated fats, and especially trans-fatty acids, has been linked to higher blood cholesterol levels, and thus a higher risk of cardiovascular disease. In response to this, the World Health Association has recommended the reduction on the consumption of trans fats and saturated fats. Furthermore, a large part of the population does not consume or limit the consumption of food products of animal original as part of their diet.

In an embodiment, an exemplary vegan cheese product embodying features of the present invention may have any one or more of the following characteristics. As provided herein, all percentages (“%”) are as a percent of total, unless otherwise stated.

Up to 100% vegan cheese;

Substantially dairy free;

Substantially lactose free;

Substantially zero % trans fats acids;

Less total fats as compared to other commercial cheese analogues (e.g., from about 40 to about 55% less total fats;

Less saturated fats as compared to other commercial cheese analogues (from about 87 to about 97% less saturated fats);

Substantially zero % lauric acids;

% moisture from about 36 to about 42;

Hardness from about 235 to about 300 grams;

Less calories as compared to other commercial cheese analogues (from about 20 to about 40% less calories);

Relatively higher content of dietary fiber (up to and including about 2%);

May be formulated with non-GMO ingredients;

Substantially zero or no allergenic ingredients; and

May be formulated and manufactured to meet the requirements of Kosher and Halal.

In an embodiment the reduction of the caloric content, total fat content, and saturated fats; as compared to the other cheese analogues may be achieved by incorporation of oils in an emulsion system during the preparation process of the VCP. The emulsion system embodying features of the present invention is formulated to interact with other ingredients resulting in a homogeneous, or substantially homogeneous, oil repartition and uniform fatty acids crystallization.

In an embodiment, vegan cheese product may be formed from an emulsion mixture and a powder blend. In an embodiment, the emulsion mixture may be formed from at least one emulsifier, such as lecithin, mono and diglyceride, or other suitable emulsifier, or combinations thereof. In an embodiment, the powder blend may be formed from at least one vegetable protein concentrate comprising at least one vegetable protein, at least one flour, and at least one hydrocolloid. In an embodiment the powder blend further include, independently at least one vegetable microfiber, and at least one salt (e.g., mineral salt).

In an embodiment, an exemplary method for preparing vegan cheese product (VCP), may include making an oil in water emulsion (e.g., water, vegetable oil, emulsifier; introducing the powder blend into a mixing vessel; combining the emulsion with the powder blend, such as by way of introducing the emulsion into the powder blend within the mixing vessel to form a mixture; heating the mixture at desired temperature, such as a plurality of temperatures; maintaining the moisture content of the mixture at a suitable level, such as under about 20% to about 30%; and shaping the resulting product.

In an embodiment the resultant edible composition of matter or VCP, may include at least one vegetable protein, at least one flour, and at least one vegetable microfiber. In an embodiment, the VCP may further include, independently, one or more of at least one hydrocolloid, at least one salt such as a mineral salt, at least one vegetable fat, and at least one enzyme.

In an embodiment, the VCP exhibits the same or substantially the same texture and quality attributes as a conventional dairy cheese. The VCP, in an embodiment, has a cheese-like structure replacing natural dairy casein and proteins with vegetable proteins with the same or substantially similar functional properties and high meltability. The VCP emobodying features of the present invention may be used alone or as part of edible products normally including dairy cheese.

It should be understood that the aforementioned implementations are merely exemplary, and that claimed subject matter is not necessarily limited to any particular aspect of these exemplary implementations.

### DRAWINGS

Non-limiting and non-exhaustive features of the present invention are described with reference to the following figures, wherein like reference numerals refer to like parts throughout the various figures.

FIG.1 is a schematic of an exemplary process for making a cheese substitute product (or vegetarian/vegan cheese product or VCP) embodying features of the present invention.

FIG. 2 is schematic of exemplary steps for preparing the water in oil emulsion stage of FIG. 1.

FIG. 2A is schematic of exemplary step for preparation of a homogenized emulsion of FIG. 2.

FIGS. 3A-3D are visual representations of various VCP made at different pH levels.

FIGS. 4A-4D are visual representations of different mixtures having different ingredients in the powder blend.

FIG. 5 is chart showing the effect of time on harness of VCD embodying features of the present invention.

### DETAILED DESCRIPTION

The present disclosure is directed to vegetarian, preferably, vegan, cheese compositions/products (“VCP”) and methods for making and using the same.

It should be understood that numerous specific details, relationships, and methods are set forth to provide a full understanding of the invention. One having ordinary skill in the relevant art, however, will readily recognize that the invention can be practiced without one or more of the specific details or ingredients or with other methods. As provided herein, all percentages (“%”) are as a percent of total weight, unless otherwise stated.

The VCPs embodying features of the present invention may be formulated as vegan and/or non-vegan, preferably vegan, to suit a variety of products, including omelets, pastries, snacks; and baking products (e.g., muffins, cakes, baguettes, breads).

The VCPs embodying features of the present invention may be formed from: an emulsion mixture and a powder blend. In an embodiment, the emulsion mixture may be formed from at least one emulsifier, such as lecithin, mono and/or diglyceride, or other suitable emulsifier, or combinations thereof. In an embodiment, the powder blend may comprise at least one vegetable protein concentrate comprising at least one vegetable protein, at least one flour comprising at least one starch, and at least one hydrocolloid. In an embodiment the protein concentrate comprises at least pea protein.

In an embodiment the powder blend further includes, independently, one or more of: at least one vegetable microfiber, at least one salt (e.g., mineral salt), and at least one microbial agent.

In an embodiment the flour comprises one or more of tapioca flour and rice flour.

Vegan Cheese Product (VCP)

In an exemplary embodiment, the VCP comprises the following as provided in Table 1

TABLE 1

| | VCP Composition (% w/w) | | |
|---|---|---|---|
| Ingredient | Normally | Typically | Generally |
| Protein | From about 8 | From about 5 | About >4 |
| concentrate | to about 10 | to about 7 | |
| (e.g., pea) | | | |
| Flour (e.g., | From about >15 | From about >15 | About >15 |
| tapioca) | to about 17 | to about 20 | |
| Fat (e.g., | From about >15 | From about 20 | About >15 |
| safflower oil) | to about 17 | to about 25 | |
| Dietary fiber | About 1 | From about 0.5 | About >0.5 |
| | | to about 1 | |
| Salt | About 1.50 | From about 1.0 | From about 1 |
| | | to about 1.5 | to about 2 |
| Natural Flavor | From about 2.5 | From about 2.5 | About >2.0 |
| | to about 3.5 | to about 3.0 | |

In an exemplary embodiment, the VCP may comprise, independently, one or more flours (starches) as provided in Table 2.

TABLE 2

| | VCP (% w/w) | | |
|---|---|---|---|
| Type of Flour/Starch | Normally | Typically | Generally |
| Tapioca | From about 15 | From about 15 | >15 |
| | to about 20 | to about 17 | |
| Rice | From about 7 | From about 7 | >5 |
| | to about 10 | to about 8 | |
| Potato | From about 2 | From about 2 | >=0 |
| | to about 3 | to about 4 | |
| Sweet Potato | From about 1.0 | From about 0.5 | >=0 |
| | to about 1.5 | to about 1.0 | |

In-Process Vegan Cheese Product

As used herein an IPM (in-process mixture) refers to the mixture prepared during the manufacturing process and which will result in the final edible VCP. In an exemplary embodiment, an in-process mixture (“IPM”) may be formed from the following as provided in Table 3.

TABLE 3

| Ingredient | IPM formed from (% w/w) |
|---|---|
| Powder blend | From about 25 to about 35 |
| Water in oil (w/o) emulsion | From about 15 to about 25 |
| Water | From about 45 to about 55 |
| Mineral salt | From about 0.5 to about 1.5 |
| Flavor (e.g., mozzarella, gouda or | From about 0.2 to about 1 |
| cheddar flavor) | |

As used herein, the termed ‘formed from’ refers to preparing a secondary material/mixture/product from one or more staring material/mixtures/products regardless of whether the starting material maintains its original composition in the secondary material/mixture/product. The concentration of the starting material is reported as weight of starting material as a percentage of the total weight of all other materials in the secondary material, unless otherwise stated.

In an exemplary embodiment, the IPM may be formed from the following as provided in Table 4.

TABLE 4

| | IPM formed from (% w/w) | | |
|---|---|---|---|
| | Normally | Typically | Generally |
| Protein (e.g., pea) | From about 8 | From about 5 | About >4 |
| | to about 10 | to about 12 | |
| Flour (e.g., tapioca | From about 15 | From about 13 | About >15 |
| starch) | to about 20 | to about 20 | |
| Fat (e.g., safflower | From about 15 | From about 20 | About >15 |
| oil) | to about 17 | to about 25 | |
| Dietary fiber | 1 | From about 0.5 | About >0.5 |
| | | to about 1 | |
| Salt | 1.50 | From about 1.0 | From about 1 |
| | | to about 1.5 | to about 2 |
| Flavor | From about 2.5 | From about 2.5 | About >2.0 |
| | to about 3.5 | to about 3.0 | |

Powder Blend

In an exemplary embodiment, the powder blend may comprise, independently, the following as provided in Table 5.

TABLE 5

| Ingredient | Powder Blend (% w/w) |
|---|---|
| Flour mixture | from about 70 to about 85 |
| Vegetable protein | from about 5 to about 15 |
| concentrate | |
| Hydrocolloids | from about 1 to about 8 |
| Vegetable microfibers | from about 2 to about 8 |
| Mineral Salts | from about 1 to about 8 |
| Antimicrobial agents | 0.2 |

In an embodiment, the ratio of the starch:hydrocolloid:protein is about 7:2:1. In an embodiment, the starch comprises tapioca starch and rice starch; and the protein comprises pea protein. In an embodiment, the starch comprises tapioca starch.

Flour Mixture

In an embodiment, the flour mixture may include one or more of maize starch, rice starch, tapioca starch, potato starch, pea starch, and any other suitable flour, or combinations thereof. In an embodiment, the ratio of rice starch, potato starch, and pea starch is about 20:10:70.

In an exemplary embodiment, the flour mixture may comprise the following as provided in Table 6.

TABLE 6

Flour Mixture (% w/w)

| Ingredient | Normally | Typically | Generally |
|---|---|---|---|
| Total starch | About 25 | From about >15 | About >15 |
| | | to about 25 | |
| Tapioca | About 20 | From >15 | About >15 |
| starch | | to about 25 | |
| Rice starch | About <5 | About <7 | From about 0 |
| | | | to to about 10 |
| Potato | About <2 | From about 5 | From about 0 |
| starch | | to about 7 | to about 7 |
| Corn starch | 0 | From about 1 | From about 0 |
| | | to about 2 | to About 2 |

In an embodiment, the flour mixture comprises at least rice and tapioca flours. In an embodiment a mixture of both tapioca and rice flour may aid in producing a more desirable and consistent texture (e.g., compared to only using tapioca flour which may yield a more chewy gummy texture).

In an exemplary embodiment, the flour mixture may comprise the following as provided in Table 7.

TABLE 7

| Ingredient | Flour Mixture (% w/w) |
|---|---|
| Tapioca flour | From about 50 to about 80 |
| Rice flour | From about 20 to about 50 |

Tapioca starch, as formulated according to the present invention, has a relatively high viscosity, excellent water-holding capacity and binding ability. It is band and clean in flavor. Once heated it forms a clear gel exhibiting a long and slightly stingy texture. Upon cooling, it sets to a to soft gel. Once cooked, the gel resembles that of a potato but with less stringy texture and a more neutral flavor, suitable for use as a thickener. Tapioca starch, further provided the desired moisture retention and cell size.

The IPM embodying features of the present invention and including tapioca starch and pea protein provide the desirable meltability and strand capacity for the final edible VCP.

Vegetable Protein

In an embodiment, the vegetable protein concentrate may include one or more of pea protein, amaranth protein, chickpea protein, lima beans protein, lentil protein; and any other suitable vegetable protein; or combinations thereof. In an embodiment, the protein concentrate does not include any or substantially any soy bean protein to minimize allergenic reactions.

In an exemplary embodiment, the protein concentrate may be formed from the following as provided in Table 8.

TABLE 8

| | Protein Concentrate (% w/w) | | |
|---|---|---|---|
| | Normally | Typically | Generally |
| Total Protein | About 10 | From about 5 | About >4 |
| | | to about 7 | |
| Pea Protein | From about 8 | From about 5 | About >4 |
| | to about 10 | about 7 | |
| Chickpea | From about 0.5 | From about 0.5 | From about 0.0 |
| | to 2.0 | to about 1.0 | to about 0.5 |
| Lima beans | From about 0.5 | From about 0.5 | From about 0.0 |
| | to about 2.0 | to about 1.0 | to about 0.5 |
| Lentil | From about 0.5 | From about 0.5 | From about 0.0 |
| | to about 2.0 | to about 1.0 | to about 0.5 |

In an embodiment the IPM and/or VCP comprise a protein as provided in Table 8.

In an embodiment, the vegetable protein concentrate further includes yeast extract concentrate.

In an embodiment, the vegetable protein comprises pea protein. In an embodiment, the vegetable protein concentrate comprises at least about 50% to about 80% (% w/w) pea protein.

In an exemplary embodiment, the pea protein comprises the following amino acid profile as provided in Table 9.

TABLE 9
Exemplary Amino Acid Profile of Pea
Protein
% w/w pea protein
(N × 6.25)/DS

| Amino Acid | % w/w |
|---|---|
| Aspartic acid | 11.5 |
| Glutamic acid | 16.7 |
| Alanine | 4.3 |
| Arginine | 8.7 |
| Cystine | 1 |
| Glycine | 4 |
| Histidine | 2.5 |
| Isoleucine | 4.7 |
| Leucine | 8.2 |
| Lysine | 7.1 |
| Methionine | 1.1 |
| Phenylalanine | 5.5 |
| Proline | 4.3 |
| Serine | 5.1 |
| Threonine | 3.8 |
| Tyrosine | 3.8 |
| Valine | 5 |
| Tryptophane | 1 |

Protein concentrate, comprising pea protein, and usable in preparation of the VCFs embodying features of the present invention, independently: normally has at least about 80% w/w protein as measured using Dumas method; normally has a viscosity of about 500000 mPa·s min. for an emulsion of 1/5/5 protein/water/oil measured after 24 hour storage at 4° C.; and at 10% w/w normally has a pH of about 7.

Table 10 is an exemplary set of values of amino acids found in whole milk.

TABLE 10
Exemplary Amino Acid Profile of Whole
Milk % w/w

| Ingredient | % w/w |
|---|---|
| Arginine | 3.4 |
| Histidine | 2.7 |
| lsoleucine | 5.8 |
| Leucine | 9.2 |
| Lysine | 7.6 |
| Methionine | 2.7 |
| Phenylalanine | 4.8 |
| Threonine | 3.7 |
| Tryptophan | 1.5 |
| Valine | 5.9 |

In some embodiments, pea protein provides for a better amino acid profile, as it relates to relevant amino acids, than whole milk. Table 11 provides an exemplary set of values of a VCP prepared using whole milk and VCP using pea protein and embodying features of the present invention.

TABLE 11

Amino Acid Profile of
Cheese % w/w

| | Made from whole | |
|---|---|---|
| Amino acid | milk | VCF |
| Alanine | 0.103 | 0.149 |
| Arginine | 0.075 | 0.302 |
| Aspartic acid | 0.237 | 0.399 |
| Cystine | 0.017 | 0.035 |
| Glutamic acid | 0.648 | 0.572 |
| Glycine | 0.075 | 0.139 |
| Hystidine | 0.075 | 0.087 |
| Isoleucine | 0.165 | 0.163 |
| Leucine | 0.265 | 0.284 |
| Lysina | 0.14 | 0.246 |
| Metionine | 0.075 | 0.038 |
| Phenylalanine | 0.147 | 0.191 |
| Proline | 0.342 | 0.149 |
| Serine | 0.107 | 0.177 |
| Threonina | 0.143 | 0.132 |
| Tyrosina | 0.152 | 0.132 |
| Tryptophane | 0.075 | 0.035 |
| Valine | 0.192 | 0.173 |

In an embodiment, the VCP embodying features of the product has a higher concentration of one or more of targinine, hystidine, lysine, and phenylalanine; as compared to a cheese prepared by whole milk. In an embodiment, the VCP embodying features of the product has a higher concentration of arginine, hystidine, lysine, and phenylalanine; as compared to a cheese prepared by whole milk.

Hydrocolloid

In an embodiment, the hydrocolloid may include one or more of carrageenan, xanthan gum, carboxymethylcellulose, sodium alginate, methyl cellulose, and any other suitable hydrocolloid; or a combination thereof. In an embodiment, the concentration of hydrocolloid may range from about to 1% to about to 8%.

Vegetable Microfiber

In an embodiment, the vegetable microfiber may include one or more of oat microfiber, bamboo microfiber, and any other suitable vegetable microfiber; or combinations thereof.

Mineral Salts

In embodiment, the salt may comprise mineral salt including, but not limited to, one or more of tricalcium citrate, sodium citrate, disodium phosphate, calcium sulfate, sea salt, titanium dioxide, and any other suitable mineral salt; or combinations thereof.

In an embodiment, the VCP may comprise, independently: tricalcium citrate from about 0.5% to about 1%, sodium citrate from about 0.5 to about 1%, disodium phosphate from about 0.5% 1%, calcium sulfate from about 0.1-0.5%, sea salt from about 0.5% to about 2%, titanium dioxide (from about 0.05% to about 0.35%.

Antimicrobial Agent

In an embodiment, the antimicrobial agent may include one or more of potassium sorbate, lactic acid, and any other suitable antimicrobial agent; or combinations thereof.

In an embodiment, the VCP may comprise, independently: potassium sorbate from about 0.05% to about 0.3% lactic acid from about 0.05% to about 0.3%, and any other suitable antimicrobial agent; or combinations thereof.

Water and Oil Emulsion (W/O)

The water in oil emulsion comprises a vegetable fat (or oil), water, and emulsifying agents. In an embodiment the water in oil emulsion comprises the following as shown in Table 12.

TABLE 12

| Composition | % w/w |
|---|---|
| Vegetable Oil | from about 55 to about 70 |
| Water | from about 35 to about 60 |
| Emulsifier agents | from about 1 to about 3 |

Fat/Oil

The vegetable oil may include one or more of sunflower oil, palm oil, safflower oil, and any other suitable vegetable oil; or a combination thereof. In an embodiment, only one type of vegetable oil is used.

In an exemplary embodiment, VCF comprises, independently, the following fats/oils as provided in Table 13.

TABLE 13

| | VCP (% w/w) | | |
|---|---|---|---|
| | Normally | Typically | Generally |
| Safflower oil | From about | From about | About >15 |
| | 15 to about | 20 to about | |
| | 17 | 25 | |
| Sunflower oil | From about | From about | About >15 |
| | 15 to about | 20 to about | |
| | 17 | 25 | |
| Canola oil | From about | From about | About >15 |
| | 15 to about | 20 to about | |
| | 17 | 25 | |
| Corn oil | From about | From about | About >15 |
| | 15 to about | 20 to about | |
| | 17 | 25 | |

In an exemplary embodiment, IPP is formed from, independently, the following fats/oils as provided in Table 13.

TABLE 14

| | Fats/Oils (% w/w) | | |
|---|---|---|---|
| | Normally | Typically | Generally |
| Total fat/oil | About 25 | From about | About >15 |
| | | 15 to about | |
| | | 20 | |
| Safflower oil | About 20 | From about | About >15 |
| | to about 25 | 15 to about | |
| | | 20 | |
| Sunflower oil | From about | From about | About >10 |
| | 15 to about | 15 to about | |
| | 20 | 20 | |
| Canola oil | About 5 | From about | About >5 |
| | | 5 to about 10 | |
| Corn oil | About 5 | From about | About >5 |
| | | 5 to about 10 | |

Emulsifying Agent

The emulsifying agent may include one or more of lecithin, mono and diglycerides, and any other suitable emulsifier agent; or combinations thereof. In an embodiment for the W/O emulsions according to embodiments of the present invention, the stabilizing substances used are oil soluble emulsifiers. In an embodiment, suitable emulsifiers have a hydrophilic-lipophilic balance between from about 4 to about 6. In an embodiment, the emulsifier is pre-mixed in the oil phase at block 1215.

Flavorants

In an embodiment, the VCP, comprises flavoring agents. The flavoring agents may include any suitable flavoring, including any one or more of mozzarella, gouda, cheddar flavors; or combinations thereof. Exemplary flavoring agents include Artificial Mozzarella Cheese Flavor, Artificial Gouda Cheese Flavor, Artificial Cheddar Cheese Flavor, and Artificial Manchego Cheese Flavor, available from The Bell Flavors & Fragrances, Co.

Method of Making

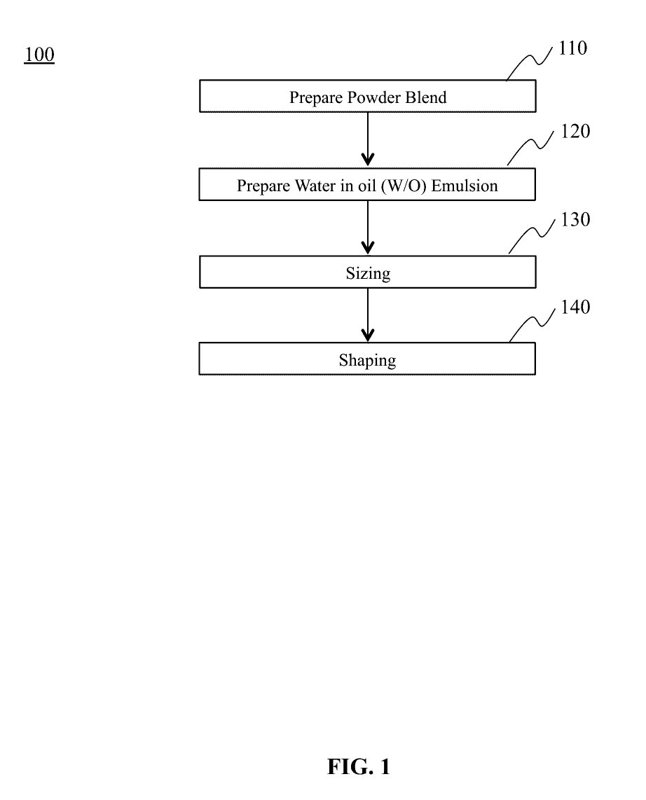

Now referring to FIG. 1 an exemplary process 100 for manufacturing a vegan cheese product and the various stages (including optional stages) is shown. In an embodiment, the process comprises preparing a powder blend (110), preparing a water in oil (W/O) emulsion (120), sizing a resulting product (130), and a molding stage (140). Steps 120 and 130, alone or together, may, in an embodiment, aid the homogeneity, stability, meltability, elasticity, and texture of the final vegan cheese product.

The powder blend of stage 110, comprises ingredients provided above and more specifically in reference to Table 5. In an exemplary embodiment, the preparation and blending of the powder blend is made in a helical ribbon blender, usually with two stainless steel choppers, for example from about 8 to about 10 Hp, at a suitable stirring speed such as from about 3000 to about 4000 RPM. In an embodiment, the ingredients are moved in both directions aiding in complete, or substantially complete, mixture of all components. The blending step may be performed for any suitable length of time, normally from about 15 to about 25 minutes.

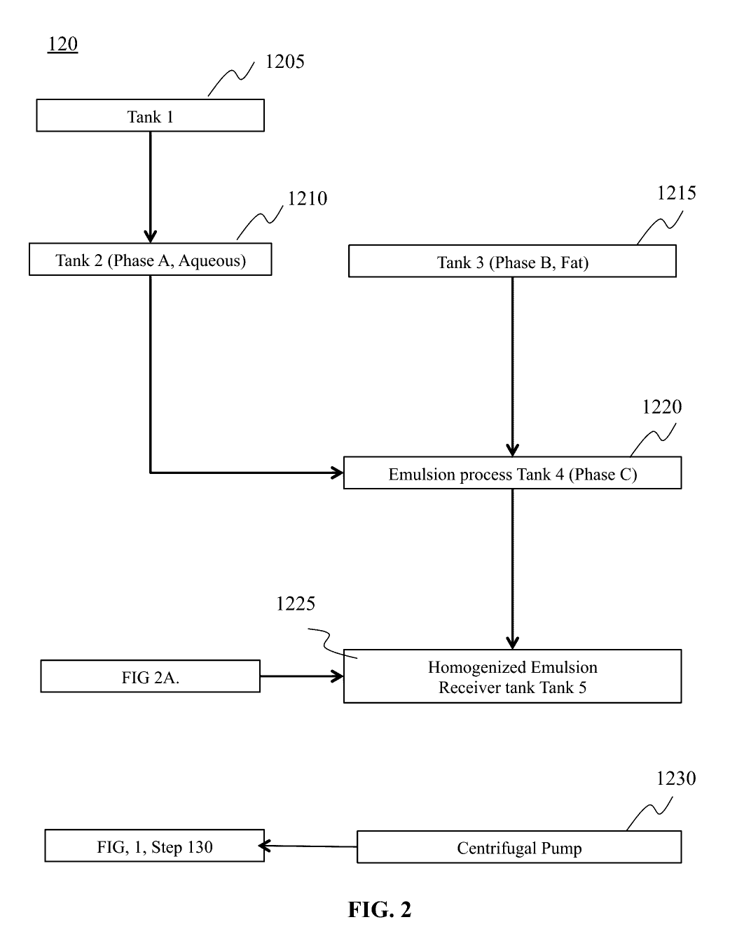

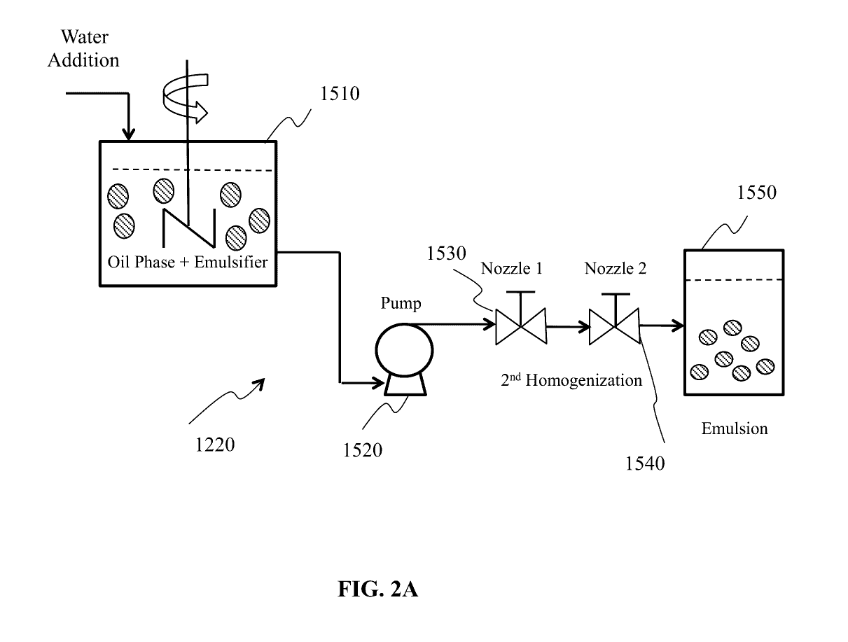

Now referring to FIG. 2, stage 120 is further described using an exemplary process embodying features of the present invention. In a block (1205) a suitable water supply is provided for preparation of an enzymatic phase (Phase A, or aqueous phase, 1210), normally comprising suitable enzymes and mineral salts; usable in the preparation of an emulsion mixture (block 1220). At block 1205, by way of example, a water supply Tank (Tank 1) having a capacity of approximately 5000 L may be utilized at a temperature ranging from about 15° C. to approximately 25° C. (“room temperature”).

The water may be pretreated in any suitable manner. For example, the water may be de-chlorinated by carbon filtration or potassium metabisulphite, or by any other suitable manner. The pH and/or hardness of water in the Tank 1 may be adjusted in any suitable manner. In an embodiment, the pH may be adjusted with lactic acid to suitable level, from about 5 to about 6.5, typically from about 5.5 to about 6.0, normally about 5.8. This pH may aid in the functionality of the protein. The feed Tank 1 may be of any suitable capacity, and, in an exemplary embodiment, may be sized at 5000L to support manufacturing operations. The pH and/or hardness of the water in the feed Tank 1 may be adjusted in any suitable manner. In an embodiment, the pH is adjusted to bring about the desirable functionality of the protein. In an embodiment, the pH is adjusted with lactic acid to about 6.5.

At step 1210 a Phase A, aqueous solution is prepared in Tank 2. In an exemplary embodiment, the water from Tank 1 is introduced to Tank 2 at a flow of about 500 to about 1500 cm3/min, at room temperature. While stirring at suitable rate, for example, between approximately 45 Hz and 80 Hz, a premix of mineral salts, is added to Tank 2.

Water may be added from the feed Tank 1 to the Tank 2 before, during, or after the addition of the ingredients to tank 2, normally during mixing of the ingredients.

In block 1215 Phase B, a vegetable fat mixture is prepared in a third tank (Tank 3), preferably a jacketed tank. The vegetable fat is heated to suitable temperature, for example, from about 55 to about 65° C., and mixed with at least one emulsifier. Once the emulsifier is added to Tank 3, the contents are mixed while maintaining the temperature, at a suitable rate, such as from about 45 Hz to 80 Hz.

Exemplary block 1220, illustrates the preparation of an emulsion mixture, as Phase A and Phase B are mixed to yield an emulsion (Phase C) at block 1220 in Tank 4.

Now referring to FIG. 2A, block 1220 is described in detail. In block 1220, Phase B is added to, Tank 4, at 1510. Phase A is mixed with Phase B while maintaining the mixture at a suitable temperature, usually at from 55 to about 65° C. while the tank is stirred, usually at about 45 to about 70 Hz. The Phase A and Phase B mixtures are mixed together and stirred for a suitable period of time, normally from about 10 to about 20 minutes, resulting in a first homogenization pre-emulsion (primary homogenization). The mixture proceeds through a pump 1520 raising the pressure normally from about 2000 to about 3000 lb./in2. The mixture thereafter proceeds through a nozzles 1530, dropping the pressure, normally to about 1600 to about 2400 lb./in2 across the nozzle 1530, resulting in a lower pressure, normally from about 400 to about 600 lb./in2 for the exiting mixture. In an embodiment, the mixture may proceed through a second nozzle and 1540 resulting in the remaining pressure dropping to atmospheric pressure. The passage of the mixture through the nozzles results in the second homogenization (secondary homogenization). In an embodiment, the resulting Phase C emulsion has a particle size of less than about 1 to about 10 μm. The Phase C emulsion then proceeds to a fifth tank (receiving tank) 1550 (same as 1225 in FIG. 2).

The process of converting two immiscible liquids into an emulsion by reducing the size of the droplets is known as homogenization. The emulsion that may be used in some embodiments may be produced in a two-step homogenization process comprising a primary homogenization and a secondary homogenization.

In the primary homogenization, the resulting mixture is a pre-emulsion with large droplets (e.g., from about 50 to about 100 μm) dispersed in a continuous oil phase.

In the secondary homogenization, the droplets of the pre-emulsion are further reduced in size using a high pressure homogenizer such as a valve homogenizer (HPH). In an embodiment, the homogenizer comprises a plunger pump 1520 that impulses the pre-emulsion creating a turbulent flow and two nozzles 1530 and 1540 in which the flow is restricted aiding in the pressure increase. These flow restrictions may aid in the reduction of the size of the droplets (e.g., from about 1 to about 10 μm). In an embodiment, the pressure may reach values close to about 2000 to about 3000 lb./in2. As the liquid passes through the nozzle gaps of nozzles 1530 and 1540 this pressure may be discharged by expansion of the liquid droplets (known as cavitation). The shear forces at the nozzles 1530 and 1540 may aid in the collapse of the cavitational bubbles, dispersing them into small particles that reverts the flow to a one-phase flow that exits the nozzles 1530 and 1540 as an emulsion.

To aid in the control of the droplet size reduction (shear, cavitation, turbulence), the homogenization pressure may be regulated by the force exerted over the nozzles 1530 and 1540.

The rheological properties, melting and texture of the vegan cheese product maybe influenced by the fat globule size, which alters the amount of protein bonds in the emulsion. These characteristics may be affected by the fats composition, which alters the manner in which the proteins are adsorbed onto the fat surface and the way in which the emulsification process occurs, resulting in different particle sizes. In an embodiment, the fat globules may be covered by a viscoelastic membrane which may aid them to behave as relatively rigid spheres. The continuous phase (or protein phase in this instance) aids in control of the behavior of the emulsion.

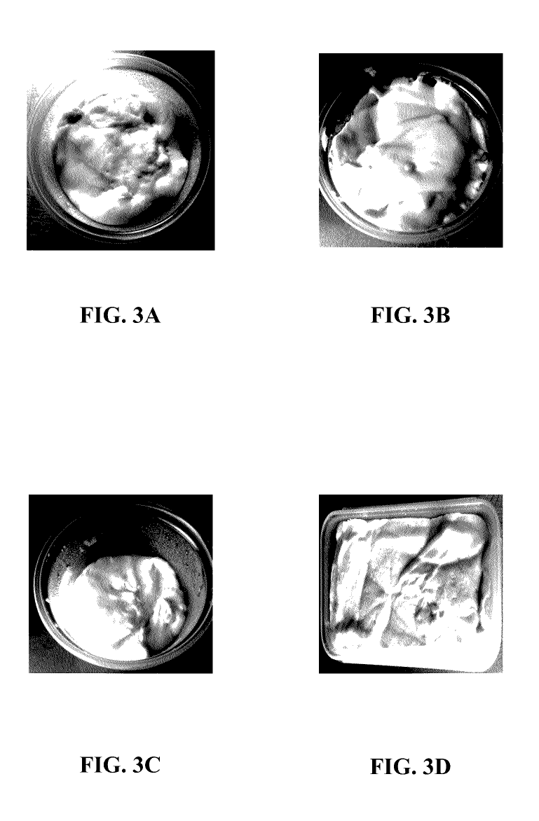

Now referring back to FIG. 2, at block 1225, once Phase C emulsion is placed in the receiving tank 1550 (refer back to FIG. 3B), it is continuously stirred at a suitable rate, normally from about 45 to about 70 Hz. The powder blend from stage 110 is added to the receiving tank and the while maintain the stirring, until the resulting mixture is a homogeneous paste. Thereafter the water, salts, and flavors are added to the tank while maintaining the stirring until a mixture has reached the desired consistency (typically a homogeneous paste).

At a block 1230 the homogeneous paste is passed through a centrifugal pump, normally from about 1 to about 2 Hp.

Now referring back to FIG. 1, in an exemplary sizing stage 130 the mixture is run through a cutting process system. The operating temperature and pressure, during the sizing process, may independently be; generally up to about 95 ° C., typically greater than 80 ° C., usually from about 80 to about 90° C., and normally about 85° C.; and 0.5 bar, respectively. The motor drive for the cutting system may have a suitable capacity, for example about 65 kW (87 Hp), a speed of about 360 to about 3600 rpm (e.g., frequency controlled), and a voltage/frequency of 450 to about 500 V/50-70 Hz. In an embodiment the he cutting system may be mounted in the bottom of the vessel with a design of three knives, cranked (canted).

The cutting system is used for the preparation of a homogeneous cheese blend. The cutting system may be a tilted processing vessel, equipped with high-speed knives and an additional mixing element in the bottom of the machine. The product may be heated by direct steam injection, optionally combined with a dynamic and highly efficient mixing system (such as a Stephan Combitherm CT 1200).

The product of stage 130 may optionally be thereafter shaped into suitable shape, at stage 140 using suitable methods and equipment, such as a molding machine. The vegan cheese product is thereafter ready for use.

While steps of a process 100 and its sub-steps have been described in a particular order, those steps may be performed in any other suitable order.

Examples/Composition And Process Parameter Impact

The functional properties of VCP may be affected by its composition, such as the water content, emulsifying agents, protein to fat ratio, and pH range. The physicochemical properties of vegan cheese may be affected by the process steps, such as the agitation speed. Examination of the microstructure of the cheese played a role in understanding the effect of the auger/blade speed on the physical properties of vegan cheese. In some embodiments, increasing agitation speed may have affected the microstructure of VCP by decreasing the fat globule size and improving their distribution throughout the protein matrix. This change in microstructure may have resulted in a change in cheese color, the reduction in fat globule size making the cheese whiter and less yellow, possibly through increased light scattering.

The meltability of vegan cheese is another desirable characteristic of VCP as they are used in heated or cooked foods. The meltability of cheese is related to fat globule size. In an embodiment, increasing the blade speed reduced the fat globule size and extensively sheared the protein matrix to create a more tightly knitted structure, in which fat globules were finely distributed. This newly formed matrix required more energy to melt and to initiate and sustain the cheese flow.

Example: Effect of Blade Speed on VCF Hardness

In an embodiment, increasing the blade speed in the cutting system increased vegan cheese product hardness and this increase could be accounted for by the noticeable reduction in the overall fat globule size and changes to the protein matrix. In an embodiment, vegan cheese product manufactured in the cutting system at 1,500 rpm contained smaller-sized fat globules. In some embodiments, these smaller sized globules are coated with vegetal protein to stabilize the expanded fat globule surface area. The vegetal protein adsorbed onto the fat globule surfaces may have interacted with the vegan cheese product vegetal protein matrix thus contributing to its strength. The chopping action of the cutting system cuts the protein matrix into smaller protein fragments leading initially to a softer cheese matrix. The increased cutting of the protein matrix also results in increased numbers of proteins to stabilize the expanded fat globule surface area which may lead to new exposed sites available for interaction with other protein molecules.

Example: Effect of pH on VCF Texture

In an embodiment, the pH of at step 1205 demonstrated an effect on the melting properties, stretching and molding of the VCP. In some embodiments, the pH affected vegetable proteins, unfolding the proteins at pH of about 6.5, increasing the hydrophobic sites of the protein, aiding the emulsification process and resulting structure. In an embodiment, water acidification during the process (step 1205) enabled greater efficiency in the process, reducing the time of emulsification and production of the VCP by 30%, compared to a conventional cheese process; resulting in energy savings, lower product cost, and overall process efficiency.

To evaluate the effect of pH during the manufacturing process (step 1205), several sets of VCP were made, each set at a different pH at step 1205. The texture of the resulting VCP was evaluated using sensory and visual evaluation methods, as reported in Table 16.

TABLE 16

| | Sensory | |
|---|---|---|
| pH | Description | Visual texture |
| From about 5.0 to | Fatty | FIG. 3A |
| about 5.5 | Grainy | |
| | Creamy color | |
| From about 5.5 to | Rubbery | FIG. 3B |
| about 6.0 | Sticky | |
| | Creamy color | |
| From about 6.0 to | White-cream color | FIG. 3C |
| about 7.0 | Creamy texture | |
| | Very malleable | |
| | Oiling out | |
| About 8.0 | Little malleable | FIG. 3D |
| | Sticky | |
| | Grainy | |
| | Neutral taste | |

Example: Effect of Powder Blend Ingredient Ratio on VCP

Several sets of powder blend mixed with fats and water were made, each set having different powder blend (starch, hydrocolloid, protein) composition. The resulting products was evaluated for meltability and strand capacity.

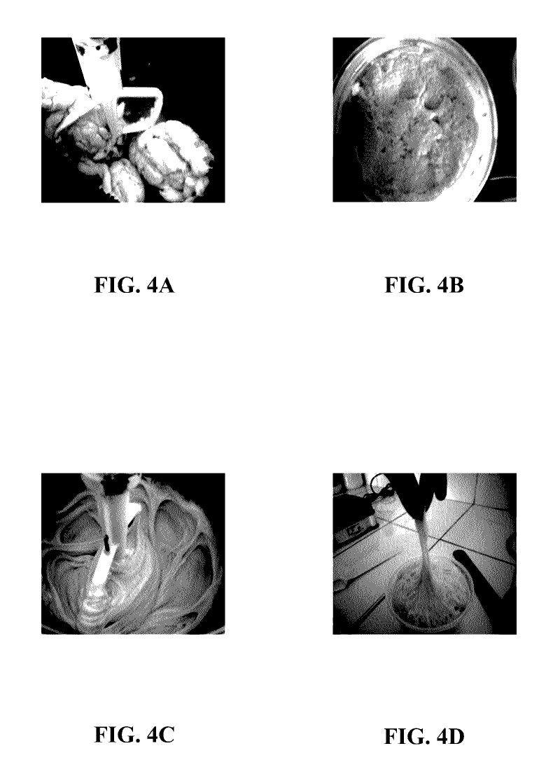

As can be seen from FIGS. 4A through 4D, while the products shown in FIGS. 4A and 4B were hard, low strand capacity, and grainy; products made from powder blend having a combination of tapioca starch, hydrocolloid, pea protein with weight ratio of 7:2:1 demonstrated the best strand capacity and meltability.

Example: Effect of Protein on Functionality of VCP

Two sets of VCPs, each set comprising several samples, were prepare, one set using pea protein and the other using chickpea protein. The resultant VCP were evaluated for several parameters as shown in Table 17.

TABLE 17

Effect on VCP

| Parameter | Pea Protein | Chickpea |
|---|---|---|
| Mealtability | High | Medium |
| Strech capacity | Large Strands | Short Strand |
| Oiling Out | Low | No Tested |

Example: Properties of Various Starches

Several samples for different types of starches were evaluated for various parameters/properties, the results of which are shown in Table 18.

TABLE 18

| | Starch | | |
|---|---|---|---|
| | Tapioca | | Corn |
| Parameter/Property | Starch | Rice starch | Starch |
| Color | White | White | Yellow |
| Flavor | Neutral | Neutral | Corn |
| | | | flavor |
| Solubility of starch | High | Suspension of | Precipitate |
| | | powder | |
| Amilose | Low | Very low | High |
| Amilopectine | High | High | Low |
| Glucose content | Low | Low | Low |

Example: Effect of Starch on Functionality of VCP

Three sets of VCPs, each set comprising several samples, were prepare, each set using a different starch. The resultant VCP were evaluated for several parameters as shown in Table 19.

TABLE 19

| | Effect on VCP | | |
|---|---|---|---|
| Parameter | Tapioca Starch | Rice Starch | Corn Starch |
| Oiling out | Low | Low | High |
| Meltability | High | High | Not Tested |
| Gelation capacity | High | Low | Not tested |
| Strands | Large | Large | Short |
| Moisture capacity | High | High | Not tested |

Example: Properties of Various Oils/Fats

Several samples for different types of fats/oils were evaluated for various parameters/properties, the results of which are shown in Table 20

TABLE 20

| | Fat/Oil | | |
|---|---|---|---|
| | Safflower | Sunflower | |
| | Oil | Oil | Corn Oil |
| Saturated fatty acids | Low | Low | 5%-10% |
| | (<5%) | (<5%) | |
| Unsaturated fatty acids (omega | High | High | 80-90% |
| 6,9) | (98%) | (90%) | |
| Trans fat | 0 | 0 | 0 |
| Viscosity (Pa · s) | Low (50) | Low (60) | Low (60) |

Example: Effect of Fat/Oil on Functionality of VCP

Three sets of VCPs, each set comprising several samples, were prepare, each set using a different vegetable oil. The resultant VCP were evaluated for several parameters as shown in Table 21.

TABLE 21

| | Effect VCP | | | |
|---|---|---|---|---|
| | Safflower | Sunflower | | |
| | Oil | Oil | Corn Oil | Vegetable Fat |
| Mealtability (° C.) | 85 | 85 | 85 | 95 |
| Strech (cm) | High (20) | High (20) | High (20) | Short (<10) |
| Oiling out | High | High | High | Low |
| Hardeness (pa) | Low (500) | Low (500) | Low (500) | High (1000) |

Example: Effect of Time on the VCF Hardness

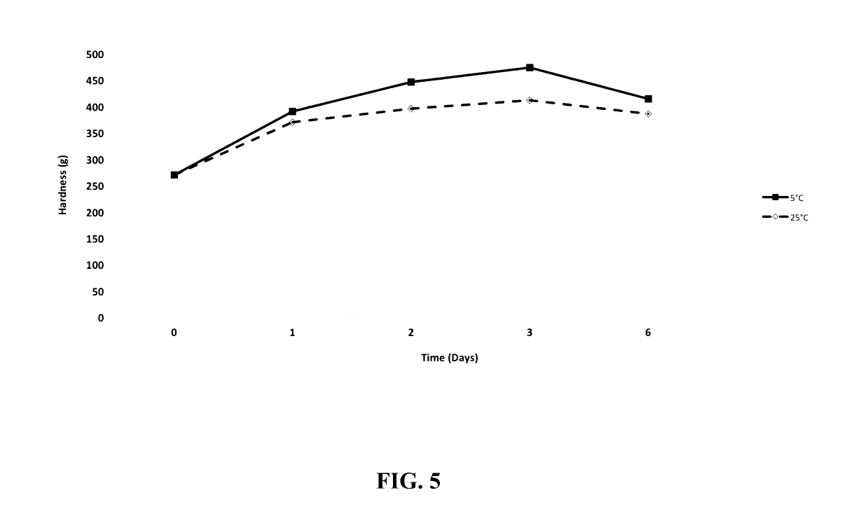

Exemplary VCPs were prepared according to the methods and compositions embodying features of the invention. The texture parameters were evaluated using a Brookfield Texture Analyzer CT3, with an adjusted cylindrical plastic (TA10 cylinder 12.7 mm in diameter and 35 mm long) measurement probe. The measurements were carried out by penetrating the probe into the VCP samples at a speed of about 1 mm/second to a depth of about 10 mm (approximately half the height of the samples). Samples were tested at two different temperatures, refrigerator temperature (e.g., about 5° C.) and room temperature (e.g., 25° C.). At least 5 measurements per sample were performed. To evaluate the effect of time on the hardness of the VCP, texture measurements were made during a period of 6 days. The results are shown in FIG. 5.

As can be seen form the FIG. 5, the hardness for samples at both temperatures reached their peaks on the third day, and thereafter decreasing slightly over the remainder of the test period. In some embodiments a VCF's may reach its optimum structural hardness at about 3 days. The refrigerated provided the highest hardness values.

As can be seen form the graph of FIG. 3, the hardness reached a peak on the third day and that position during the remainder of the study, with 5° C. providing the higher hardness value.

Table 22 shows a comparison of an exemplary vegan cheese product embodying features of the present invention and some commonly available commercial products:

TABLE 22

| | Amount per 100 gram of Cheese Product | | | | |
|---|---|---|---|---|---|
| | | | Vegan | Vegan | Non vegan |
| | | Vegan | cheese 2 | cheese 3 | white |
| | | cheese 1 | (Cheezly | (Follow | cheese |
| | | (Daiya | White | Your Heart | (Ranchero |
| | VCF | Cheddar) | Cheddar) | Cheddar) | Carranco) |
| Total Carbohydrate | From about | 25 | 18.6 | 7.15 | 5.7 |
| | 20 to about | | | | |
| | 30 | | | | |
| Dietary fiber | <=2.0 | 3.6 | 1.6 | 3.57 | N/A |
| Protein | From about | 3.6 | 3.5 | 3.57 | 21 |
| | 3 to about 5 | | | | |
| Total fat | From about | About 21.43 | 17.6 | 25 | 20 |
| | 8 to about | | | | |
| | 12 | | | | |
| Saturated Fat | <=1.0 | 7 | 10.2 | N/A | 13.3 |
| Trans Fat | 0 | 0 | N/A | N/A | N/A |
| Cholesterol | 0 | 0 | 0 | 0 | N/A |
| (mg/100 g) | | | | | |
| Calories (Kcal/100 g) | From about | 321 | 248 | 250 | 266.7 |
| | 160 to about | | | | |
| | 210 | | | | |

In an example, VCP prepared according to the present invention had the following properties as shown in Table 23.

TABLE 23

| Ingredient/Property | |
|---|---|
| per 100 g VCF | Value |
| Total carbohydrates (g/100 g) | About 23 |
| Dietary fiber (g/100 g) | About 0.30 |
| Protein (g/100 g) | About 1.91 |
| Total Fat (g/100 g) | About 9.86 |
| Saturated fatty acid (g/100 g) | About 0.70 |
| unsaturated fatty acid (g/100 g) | About 7.75 |
| Polyunsaturated fatty acid | About 1.41 |
| (g/100 g) | |
| Trans Fatty acid (g/100 g) | About 0 |
| Cholesterol (mg/100 g) | About 0 |
| Ash (g/100 g) | About 2.73 |
| Moisture (g/100 g) | About 61.93 |
| Energy (Kcal/100 g) | About 188.50 |

Under otherwise stated, the following standard methods, stated in Table 24, were used in testing the various samples.

TABLE 24

| | |
|---|---|
| Nutritional facts | (NOM-051-SCFI/SSA1-2010) |
| Energy | (NOM-051-SCFI/SSA1-2010) |
| Carbohydrates | (NOM-051-SCFI/SSA1-2010) |
| Moisture | (NMX-F-083-1986) |
| Ash | (NMX-F-607-NORMEX-2013) |
| Total Fat | (NOM-086-SSA1-1994 Appendix C, |
| | NUMERAL 1) |
| Proteins | (NMX-F-608-NORMEX-2002) |
| Dairy fiber | (NMX-F-622-NORMEX-2008) |
| Saturated fat | (NMX-F-490-1999-NORMEX) |

While embodiments have been described in detail, it will be apparent to one skilled in the art that various changes and modifications can be made and equivalents employed, without departing from the scope of the present invention. It is to be understood that embodiments are not limited to the details of construction, the arrangements of components, and/or the method set forth in the above description or illustrated in the drawings. Statements in the abstract of this document, and any summary statements in this document, are merely exemplary; they are not, and cannot be interpreted as, limiting the scope of the claims. Further, the figures are merely exemplary and not limiting. Topical headings and subheadings are for the convenience of the reader only. They should not and cannot be construed to have any substantive significance, meaning or interpretation, and should not and cannot be deemed to indicate that all of the information relating to any particular topic is to be found under or limited to any particular heading or subheading.

That which is claimed is:

1. An edible composition of matter formed from:
A powder blend comprising
At least one vegetable protein concentrate comprising at least one vegetable protein;
At least one flour mixture comprising at least one starch;
At least one hydrocolloid; and
A water in oil emulsion mixture.

2. An edible composition according to claim 1, wherein the at least one vegetable protein comprises pea protein.

3. An edible composition according to claim 1, wherein the at least one starch comprises tapioca starch.

4. An edible composition according to claim 3, wherein the at least one starch comprises tapioca starch and rice starch.

5. An edible composition according to claim 1, wherein the at least one starch, the at least one hydrocolloid, and the at least one protein are present in an approximate weight ratio of 7 to 2 to 1.

6. An edible composition according to claim 1, wherein the edible composition is a vegan cheese product.

7. A method for manufacturing a vegan cheese product, comprising:
Preparing a powder blend comprising
At least one vegetable protein concentrate comprising at least one vegetable protein;
At least one flour comprising at least one starch; and
At least one hydrocolloid;
Preparing a water in oil emulsion; and
Preparing a homogenous paste by mixing the water in oil emulsion and powder blend into a homogenous paste.

8. A method for manufacturing a vegan cheese product according to claim 7, wherein preparing the emulsion comprises the steps of:
Preparing an aqueous phase comprising the steps of
Providing a supply of water having a pH below 7;
Mixing the water supply with mineral salts;
Preparing a fat phase by mixing vegetable fats and emulsifiers; and
Mixing the aqueous phase and the fat phase forming an emulsion.

9. A method for manufacturing a vegan cheese product according to claim 8, wherein the pH is about 6.5.

10. A method for manufacturing a vegan cheese product according to claim 8, wherein the emulsion forming step comprises a two-step homogenization process.

11. An edible composition of matter comprising:
At least one vegetable protein concentrate comprising pea protein;
At least one flour mixture comprising tapioca flour and rice flour.

12. An edible composition of matter, according to claim 11, wherein the edible composition comprises at least 15 wt. % flour mixture.

13. An edible composition of matter, according to claim 11, wherein the edible composition comprises at least 4 wt. % protein concentrate.

14. An edible composition of matter, according to claim 11, wherein the edible composition comprises about 25 wt. % flour mixture and from about 8 to about 10 wt. % protein concentrate.

15. An edible composition of matter, according to claim 11, wherein the flour mixture comprises, independently from about 50 to about 80 wt. % tapioca flour and from about 20 to about 50 wt. % rice flour.
